(19) United States
(12) Patent Application Publication
(10) Pub. No.: US 2012/0167165 A1
(43) Pub. Date: Jun. 28, 2012

(54) LAWFUL INTERCEPTION TARGET APPARATUS, LAWFUL INTERCEPTION APPARATUS, LAWFUL INTERCEPTION SYSTEM AND LAWFUL INTERCEPTION METHOD

(75) Inventors: Junghak KIM, Daejeon-si (KR); Byung-Sik Yoon, Daejeon-si (KR); Song-In Choi, Daejeon-si (KR); Jee-Hwan Ahn, Daejeon-si (KR)

(73) Assignee: ELECTRONICS AND TELECOMMUNICATIONS RESEARCH INSTITUTE, Daejeon-si (KR)

(21) Appl. No.: 13/334,942

(22) Filed: Dec. 22, 2011

(30) Foreign Application Priority Data
Dec. 23, 2010 (KR) 10-2010-0133799

(51) Int. Cl. G06F 17/00

(52) U.S. Cl. 726/1

(57) ABSTRACT

A lawful interception apparatus, a lawful interception target apparatus and a lawful interception system are provided. If a lawful interception target apparatus accesses a new communication network which has no lawful interception authority, the lawful interception apparatus receives intercept activation information from the lawful interception target apparatus through a communication network which has a lawful interception authority. The lawful interception apparatus performs seamless lawful interception on the lawful interception target apparatus by use of the received intercept activation information.

### CROSS-REFERENCE TO RELATED APPLICATION

This application claims the benefit under 35 U.S.C. §119(a) of Korean Patent Application No. 10-2010-0133799, filed on Dec. 23, 2010, the disclosure of which is incorporated by reference in its entirety for all purposes.

### BACKGROUND

1. Field

The following description relates to a wireless network connection and an internetworking of network.

2. Description of the Related Art

Lawful interception (LI) involves a legal interception of communication traffic that is generated from a predetermined target or transferred to the target by a law enforcement agency which has an authorization. LI needs cooperation from a communication service provider. In particular, Congress of the United States has passed the Communications Assistance for Law Enforcement Act so that a communication service provider can cooperate in lawful interception.

According to LI architecture of LI standardizations in the EU or the United States or the groups following the standardizations, an LI authority over LI targets is delegated from an LI requesting agency to a communication service provider and the communication service provider prepares for an LI function in advance to perform LI. According to the above described LI architecture, if the LI target accesses a network of other communication service provider which has no LI authority while on the move, a process of determination is required to determine whether a newly accessed terminal or user is an LI target. In addition, in order to perform LI, the communication service provider needs to newly acquire LI authority. Accordingly, the contents of communication generated before the above described processes have been completed may not be transferred to the LI requesting agency. For this reason, seamless LI is not easily achieved in a mobile network or a wireless network.

### SUMMARY

In one aspect, there is provided a lawful interception technology capable of performing seamless lawful interception on a lawful interception target even if the lawful interception target accesses a new network which has no lawful interception authority.

In one general aspect, there is provided a lawful interception apparatus including: a communication unit configured to, if a lawful interception target apparatus accesses a new communication network which has no lawful interception authority, receive intercept activation information from the lawful interception target apparatus through a communication network which has a lawful interception authority; and a lawful interception execution unit configured to perform seamless lawful interception on the lawful interception target apparatus by use of the received intercept activation information.

In another general aspect, there is provided a lawful interception target apparatus including: a storage unit configured to receive intercept activation information through a communication network which has a lawful interception authority and store the received intercept activation information; and a terminal communication unit configured to, upon accessing a new communication network which has no lawful interception authority, transfer the stored intercept activation information to a lawful interception apparatus through the new communication network.

In another general aspect, there is provided a lawful interception system including: a first network service providing apparatus configured to provide a lawful interception target with a communication service through a first communication network which has a lawful interception authority, perform lawful interception on the lawful interception target in cooperation with a first lawful interception apparatus, and generate intercept activation information; the lawful interception target apparatus configured to receive the intercept activation information from the first network service providing apparatus upon accessing the first communication network; and a second network service providing apparatus configured to, if the lawful interception target apparatus accesses a second communication network which has no lawful interception authority, provide the lawful interception target apparatus with a communication service through the second communication network, receive the intercept activation information from the lawful interception target apparatus through the second communication network_and perform seamless lawful interception on the lawful interception target apparatus in cooperation with a second lawful interception apparatus by use of the received intercept activation information.

In another general aspect, there is provided a method for performing lawful interception on a lawful interception target apparatus in a network service providing apparatus through cooperation from a lawful interception apparatus, the method including: at the network service providing apparatus, if the lawful interception target apparatus accesses a new communication network which has no lawful interception authority, receiving intercept activation information from the lawful interception target apparatus that is acquired through a communication network which has a lawful interception authority; and performing seamless lawful interception on the lawful interception target apparatus by use of the received intercept activation information.

As described above, even if a lawful interception target accesses a new network which has no lawful interception authority in the middle of roaming or handover, a network service provider can perform immediate lawful interception on the lawful interception target. This is achieved by storing intercept activation information in the lawful interception target. The intercept activation information indicates whether the target is activated for lawful interception. When the lawful interception target accesses a new network, the stored intercept activation information is automatically transferred to the network service provider.

That is, a network service provider determines whether a lawful interception target is activated for lawful interception when the lawful interception target accesses a new network and immediately performs approximate lawful interception if a result of the determination is that lawful interception has been activated. At the same time, the network service provider acquires LI authority by requesting a warrant from the lawful interception requesting agency based on lawful interception requesting agency related information that is obtained from the lawful interception target, and conducts normal lawful interception, so that seamless lawful interception is performed. Further, even if the lawful interception target is turned off while on the move, seamless lawful interception can be performed.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an example of the configuration of a lawful interception system.

FIG. 2 is a diagram illustrating an example of the configuration of a lawful interception apparatus.

FIG. 3 is a diagram illustrating an example of the configuration of a lawful interception target apparatus.

FIG. 4 is a flowchart illustrating an example of a lawful interception method.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

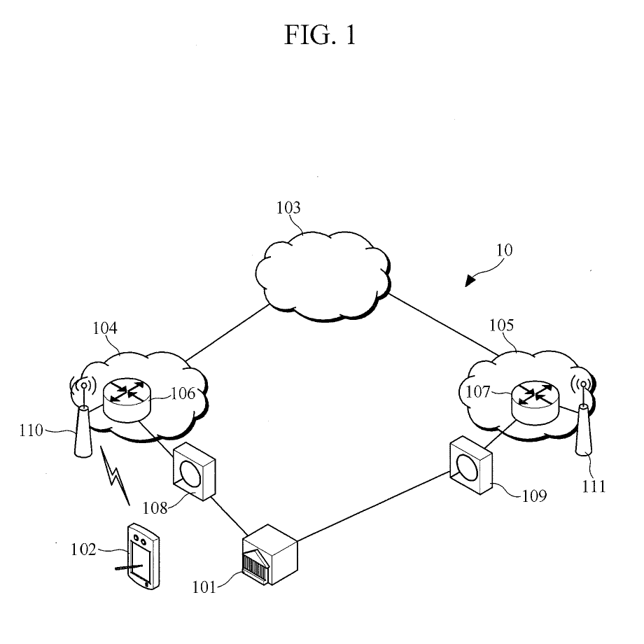

FIG. 1 is a diagram illustrating an example of the configuration of a lawful interception system.

Referring to FIG. 1, a lawful interception system 10 includes a lawful interception requesting agency 101, a lawful interception target apparatus 102, a public network 103, network service providing apparatuses including a first network service providing apparatus 104 and a second network service providing apparatus 105, network connection apparatuses 106 and 107, lawful interception apparatuses 108 and 109 and wireless access apparatuses 110 and 111.

The lawful interception requesting agency 101 requests a warrant for intercepting telecommunication traffic, which is generated from the lawful interception target apparatus 102 or transferred to the lawful interception target apparatus 102, through the court, and acquires a lawful interception authority. The lawful interception requesting agency 101 requests the network service providing apparatuses 104 and 105 to intercept communication traffic of the lawful interception target apparatus 102. The network service providing apparatuses 104 and 105 provide the lawful interception target apparatus 102 with a connection line that allows the lawful interception target apparatus 102 to connect to the public network 103. The lawful interception target apparatus 102 may include all types of electronic apparatuses capable of achieving communication through wireless/wired network.

The network service providing apparatuses 104 and 105 operate the network connection apparatuses 106 and 107, respectively, to provide connection lines for access to the public network 103. The network service providing apparatuses 104 and 105 provide the lawful interception apparatuses 108 and 109 configured to perform lawful interception on the lawful interception target apparatus 102. The network connection apparatuses 106 and 107 may be a router and a gateway. The network service providing apparatuses 104 and 105 perform lawful interception on the lawful interception target apparatus 102 through the lawful interception apparatuses 108 and 109. That is, by request of the lawful interception requesting agency 101, the network service providing apparatuses 104 and 105 analyze the communication traffic of the lawful interception target apparatus 102 through the lawful interception apparatuses 108 and 109. The network service providing apparatuses 104 and 105 transfer communication related information and communication data to the lawful interception requesting agency 101. The network service providing apparatuses 104 and 105 provide the lawful interception target apparatus 102 with the wireless access apparatuses 110 and 111.

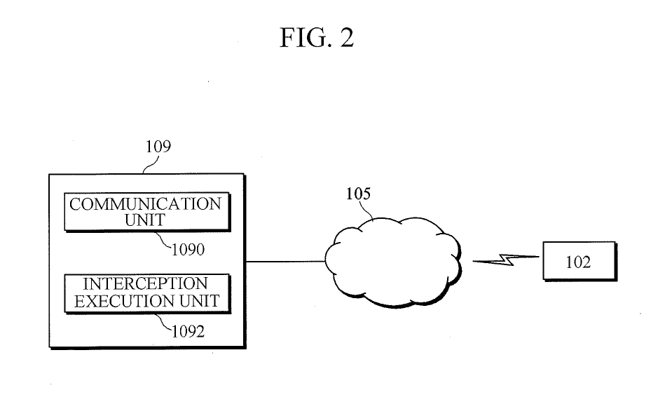

FIG. 2 is a diagram illustrating an example of the configuration of a lawful interception apparatus.

The lawful interception apparatus 109 includes a communication unit 1090 and a lawful interception execution unit 1092.

The lawful interception apparatus 109 performs seamless lawful interception on the lawful interception target apparatus 102 even if the lawful interception target apparatus 102 accesses a new communication network which has no lawful interception authority. To this end, the lawful interception apparatus 109 uses intercept activation information indicating whether the lawful interception target apparatus 102 is activated for lawful interception. The lawful interception target apparatuses 102 may access the new communication network while on the move through roaming or handover.

For example, if the lawful interception target apparatus 102 accesses a new communication network 105 which has no lawful interception authority, the communication unit 1090 of the lawful interception apparatus 109 receives intercept activation information from the lawful interception target apparatus 102. The intercept activation information is acquired through a communication network which has a lawful interception authority. The intercept activation information is automatically transferred to the lawful interception apparatus 109 when the lawful interception target apparatus 102 accesses the new communication network 105 which has no lawful interception authority.

For example, the communication unit 1090 may receive agency information about a lawful interception requesting agency, which has requested a lawful interception, from the lawful interception target apparatus 102 in addition to the intercept activation information. The communication unit 1090 may request a lawful interception authority from the lawful interception requesting agency by use of the received agency information.

For example, the communication unit 1090 requests permission for intercept activation and a lawful interception authority from a lawful interception requesting agency. If the communication unit 1090 acquires the lawful interception authority from the lawful interception requesting agency, the communication unit 1090 transfers a result of lawful interception, which is acquired through a lawful interception execution unit 1092, to the lawful interception requesting agency.

The lawful interception execution unit 1092 performs seamless lawful interception on the lawful interception target apparatus 102 by use of the intercept activation information that is received through the communication unit 1090. The lawful interception execution unit 1092 determines whether the lawful interception target apparatus 102 is activated for lawful interception by use of the intercept activation information. If a result of the determination is that the lawful interception target apparatus 102 is activated for lawful interception, communication traffic of the lawful interception target apparatus 102 is analyzed.

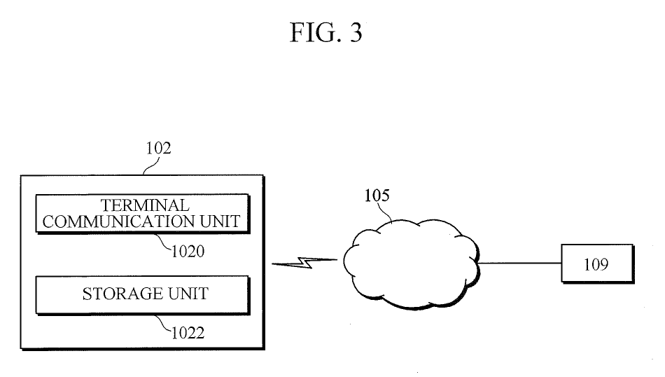

FIG. 3 is a diagram illustrating an example of the configuration of a lawful interception target apparatus.

Referring to FIG. 3, the lawful interception target apparatus 102 includes a storage unit 1022 and a terminal communication unit 1020.

When the lawful interception target apparatus 102 connects to a communication network which has a lawful interception authority, the storage unit 1022 receives intercept activation information from a network service provider of the communication network_and stores the received intercept activation information. If the lawful interception target apparatus 102 accesses a new communication network of a network service provider which has no lawful interception authority, the terminal communication unit 1020 transfers the intercept activation information, which is stored in the storage unit 1022, to the lawful interception apparatus 109 through the new communication network.

The storage unit 1022 may receive agency information about an agency, which has requested lawful interception, through the communication network which has a lawful interception authority together with the intercept activation information, and store the received agency information and the intercept activation information. At this time, the terminal communication unit 1020 may transfer the agency information and the intercept activation information, which are stored in the storage unit 1022, to the lawful interception apparatus 109.

The storage unit 1022 may store the intercept activation information which is encrypted or store the intercept activation information in a space to which a user is denied access. It is not that the storage unit 1022 stores a warrant for lawful interception but a user of a terminal corresponding to the lawful interception target apparatus 102 may figure out whether the lawful interception target apparatus 102 is in an interception activated state. In order to prevent the user from figuring out the state of the lawful interception target apparatus 102 involving lawful interception, the storage unit 1022 may store the intercept activation information which is encrypted or may store the intercept activation information in a space to which the user is denied access. Further, false information may be stored in a terminal, which does not correspond to a lawful interception target apparatus, to prevent a user of the terminal from determining whether the terminal is a lawful interception target apparatus. Accordingly, the results of lawful interception are not revealed to a user of the lawful interception target apparatus 102 and the network service provider.

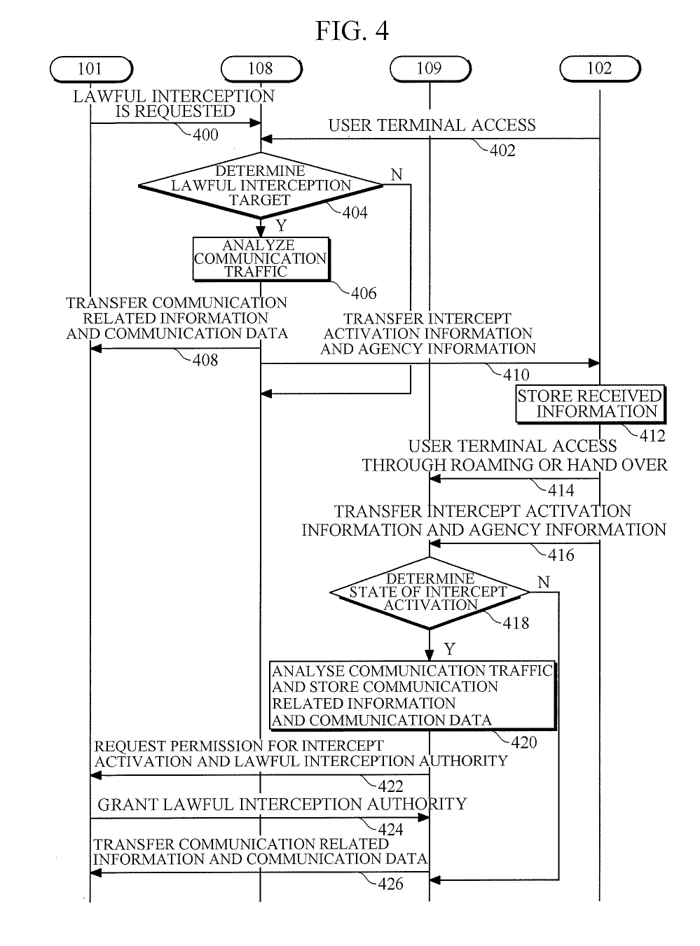

FIG. 4 is a flowchart illustrating an example of a lawful interception method.

Referring to FIG. 4, the lawful interception requesting agency 101 requests the first network service providing apparatus 104 to perform lawful interception on the lawful interception target apparatus 102 (400).

If a user accesses the network connection apparatus 106 of the first network service providing apparatus 104 by use of the lawful interception target apparatus 102 (402), the first network service providing apparatus 104 determines whether the lawful interception target apparatus 102 is a lawful interception target through the lawful interception apparatus 108 (404).

If a result of the determination is that the lawful interception target apparatus 102 is a lawful interception target, the first network service providing apparatus 104 analyses communication traffic of the lawful interception target apparatus 102 through the lawful interception apparatus 108 (406), and transfers communication related information and communication data to the lawful interception requesting agency 101 (408).

Thereafter, intercept activation information about the lawful interception target apparatus 102 and agency information about the lawful interception requesting agency 101 are transferred from the first network service providing apparatus 104 to a mobile terminal or a wireless terminal corresponding to the lawful interception target apparatus 102 (410), and then stored in the lawful interception target apparatus 102 (412).

The lawful interception target apparatus 102 accesses the network connection apparatus 107 of the second network service providing apparatus 105 through roaming or handover (414), the intercept activation information and the agency information, which are stored in the lawful interception target apparatus 102, are automatically transferred from the lawful interception target apparatus 102 to the second network service providing apparatus 105 (416).

Thereafter, the second network service providing apparatus 105 determines whether the lawful interception target apparatus 102 is activated for lawful interception, through the lawful interception apparatus 109 by use of the intercept activation information and the agency information that is transferred from the lawful interception target apparatus 102 (418).

If a result of the determination is that the lawful interception target apparatus 102 is activated for lawful interception, the second network service providing apparatus 105 analyses the communication traffic of the lawful interception target apparatus 102 through the lawful interception apparatus 109 and temporarily stores communication related information and communication data (420).

At the same time, the second network service providing apparatus 105 requests a permission for an intercept activation and a lawful interception authority on the lawful interception target apparatus 102 from the lawful interception requesting agency 101 based on the intercept activation information and the agency information, which has been transferred from the lawful interception target apparatus 102 through the lawful interception apparatus 109 (422).

Thereafter, the second network service providing apparatus 105 acquires the lawful interception authority (424), and transfers the communication related information and the communication data, which are temporarily stored in the second network service providing apparatus 105, to the lawful interception requesting agency 101 through the lawful interception apparatus 109 (426).

The present invention is applicable in the photographing control technology field and the application technology field.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A lawful interception apparatus comprising:
a communication unit configured to, if a lawful interception target apparatus accesses a new communication network which has no lawful interception authority, receive intercept activation information from the lawful interception target apparatus through a communication network which has a lawful interception authority; and
a lawful interception execution unit configured to perform seamless lawful interception on the lawful interception target apparatus by use of the received intercept activation information.

2. The lawful interception apparatus of claim 1, wherein the intercept activation information represents information indicating whether the lawful interception target apparatus is activated for lawful interception, wherein the intercept activation information is transferred from a service provider of the communication network, which has the lawful interception authority, to the lawful interception target apparatus and automatically stored in the lawful interception target apparatus.

3. The lawful interception apparatus of claim 2, wherein the intercept activation information is encrypted and stored in the lawful interception target apparatus or stored in a space to which a user is denied access.

4. The lawful interception apparatus of claim 1, wherein the communication unit receives agency information about an agency, which has requested lawful interception, from the lawful interception target apparatus, together with the intercept activation information, and requests a lawful interception authority from a terminal of the agency.

5. The lawful interception apparatus of claim 1, wherein the communication unit requests permission for intercept activation and a lawful interception authority from a terminal of an agency which has requested lawful interception, and upon acquiring the lawful interception authority, transfers a result of lawful interception performed through the lawful interception execution unit to the agency.

6. The lawful interception apparatus of claim 1, wherein the lawful interception execution unit determines whether the lawful interception target apparatus is activated for lawful interception by use of the intercept activation information, and if a result of the determination is that the lawful interception target apparatus is activated for lawful interception, analyses communication traffic that is related to the lawful interception target apparatus.

7. A lawful interception target apparatus comprising:
a storage unit configured to receive intercept activation information through a communication network which has a lawful interception authority and store the received intercept activation information; and
a terminal communication unit configured to, upon accessing a new communication network which has no lawful interception authority, transfer the stored intercept activation information to a lawful interception apparatus through the new communication network.

8. The lawful interception target apparatus of claim 7, wherein the storage unit receives agency information about an agency, which has requested lawful interception, through a communication network which has a lawful interception authority together with the intercept activation information, and stores the received agency information about the agency, and
the terminal communication unit transfers the stored intercept activation information and the stored agency information to the lawful interception apparatus.

9. The lawful interception target apparatus of claim 7, wherein the storage unit stores the intercept activation information which is encrypted or stores the intercept activation information in a space to which a user is denied access.

10. A lawful interception system comprising:
a first network service providing apparatus configured to provide a lawful interception target with a communication service through a first communication network which has a lawful interception authority, perform lawful interception on the lawful interception target in cooperation with a first lawful interception apparatus, and generate intercept activation information;
the lawful interception target apparatus configured to receive the intercept activation information from the first network service providing apparatus upon accessing the first communication network; and
a second network service providing apparatus configured to, if the lawful interception target apparatus accesses a second communication network which has no interception authority, provide the lawful interception target apparatus with a communication service through the second communication network, receive the intercept activation information from the lawful interception target apparatus through the second communication network_and perform seamless interception on the lawful interception target apparatus in cooperation with a second lawful interception apparatus by use of the received intercept activation information.

11. A method for performing lawful interception on a lawful interception target apparatus in a network service providing apparatus through cooperation from a lawful interception apparatus, the method comprising:
at the network service providing apparatus, if the lawful interception target apparatus accesses a new communication network which has no lawful interception authority, receiving intercept activation information from the lawful interception target apparatus that is acquired through a communication network which has a lawful interception authority; and
performing seamless lawful interception on the lawful interception target apparatus by use of the received intercept activation information.

12. The method of claim 11, wherein the performing of seamless lawful interception on the lawful interception target apparatus comprises:
determining whether the lawful interception target apparatus is activated for lawful interception by use of the intercept activation information; and
analyzing communication traffic that is related to the lawful interception target apparatus if a result of the determination is that the lawful interception target apparatus is activated for lawful interception, and storing a result of the analysis.

13. The method of claim 12, wherein the performing of seamless lawful interception on the lawful interception target apparatus further comprises:
requesting a permission for intercept activation and a lawful interception authority from a terminal of an agency which has requested lawful interception;
receiving the lawful interception authority from the terminal of the agency; and
transferring the result of the analysis to the terminal of the agency.
